(19) United States
(12) Patent Application Publication
(10) Pub. No.: US 2008/0052844 A1
(43) Pub. Date: Mar. 6, 2008

(54) Self-cleaning brush with a flexible matrix

(75) Inventor: William D. McKay, Grand Blanc, MI (US)

Correspondence Address: GOTTLIEB RACKMAN & REISMAN PC, 270 MADISON AVENUE, 8TH FLOOR, NEW YORK, NY, 10016-0601, US

(73) Assignee: The Hartz Mountain Corporation

(21) Appl. No.: 11/977,263

(22) Filed: Oct. 24, 2007

Related U.S. Application Data
(63) Continuation of application No. 11/480,149, filed on Jun. 30, 2006.
(60) Provisional application No. 60/771,142, filed on Feb. 7, 2006.

(51) Int. Cl. A46B 13/02; A01K 13/00; A45D 24/00; A45D 24/42

(52) U.S. Cl. 15/22.1; 119/628; 132/119; 15/160

(57) ABSTRACT

A brush assembly includes a handle and a brush head attached to the handle. The brush head includes a base with a plurality of integral bristles and a matrix. The matrix is made of sponge, foam or other compressible material. As the brush is used on a person or an animal skin or scalp, the hair or fur causes the matrix to compress and expose the bristles. When the brush is removed, the matrix springs back and removes any hair, fur, or other material entangled in the hair. Optionally a vibrating device is incorporated into the brush to provide massaging of the skin and/or scalp.

### RELATED APPLICATIONS

This application claims priority to U.S. Provisional Application Ser. No. 60/771,142 filed Feb. 7, 2006 and incorporated herein by reference.

The subject matter of this application is also related to my co-pending application Ser. No. 10/930,419, filed Aug. 31, 2004 and entitled “Liquid Dispensing Brush,” which is a continuation-in-part of co-pending application Ser. No. 10/851,503 filed May 21, 2004 and entitled “Grooming/Cleaning Apparatus” which is a continuation-in-part of co-pending application Ser. No. 10/717,956, filed Nov. 20, 2003, and entitled “Grooming/Cleaning Apparatus”, which is a continuation-in-part of co-pending application Ser. No. 10/672,909 filed Sep. 26, 2003, and entitled “Lint Removal Apparatus with Edge Orientation”, which is a continuation-in-part of Ser. No. 10/812,475 which is a continuation-in-part of co-pending application Ser. No. 10/614,551, which is a continuation-in-part of co-pending application Ser. No. 10/329,717, which is a continuation-in-part of co-pending application Ser. No. 10/302,038, now U.S. Pat. No. 6,763,977, which is a continuation-in-part of co-pending application Ser. No. 10/143,396, now U.S. Pat. No. 6,698,626; and to application Ser. No. ______ filed ______ and claiming priority to a U.S. Provisional application entitled A SELF-CLEANING HAIR BRISH WITH REPLACEABLE PRELOADED BRISTLE MAT as Ser. No. 60/774,054 filed Feb. 16, 2006, the contents of each of which are incorporated herein by reference in their entirety.

### BACKGROUND OF THE INVENTION

a. Field of Invention

This invention pertains to a brush having a base, a plurality of bristles secured to the base and a soft matrix surrounding the bristles. The matrix is arranged and constructed to compress as the brush is used on hair, and then rebound when the brushing action is completed to thereby remove any trapped hair or other matter from the bristles.

b. Description of the Prior Art

Various hair care utensils have been devised for grooming, cleaning, treating, medicating, and otherwise taking care of human or pet hair, including utensils such as combs and brushes.

Other hair grooming utensils include various spraying devices including manual pump sprays, pressurized aerosol containers, etc. These utensils are employed for applying hair coloring, cleansing solutions, medicinal compositions to treat various ailments, etc.

Conventional brushes have a plurality of bristles arranged in various two-dimensional patterns. While brushes are effective for hair grooming, they cannot apply or remove significant quantities of liquid or other materials. Conventional brushes are also less than desirable for applying medicinal or other treatment compositions to hair and scalp.

Moreover, while in use, brushes also collect loose hair, dandruff, skin flakes, as well as foreign matter stuck in the hair (especially a pet's hair), all of which get stuck between, or entangled around the bristles. All this matter is unsightly and unsanitary. Removing this matter is difficult and unappetizing. Frequently, people clean one brush by using on it another brush or a comb. However, this operation merely transfers the undesirable matter from one utensil to another thereby compounding the problem. If the matter is not removed from a brush, its repeated usage renders it ineffective, and eventually the brush is discarded even though it could be perfectly useable if it was cleaned properly.

It is desirable therefore to provide a brush which is self cleaning. It is also desirable to have a brush that is capable of applying medicine, cleansing solutions and other treatment materials to the hair, the skin or scalp as the brush is drawn through the hair.

U.S. Pat. No. 3,512,518 to Mishkin discloses a brush for collecting cellular or bacterial specimens.

U.S. Pat. No. 3,641,610 to Lewis discloses a sponge with a plurality of embedded synthetic filaments. The filaments protrude through the sponge.

U.S. Pat. No. 2,819,482 to Applegate discloses a tooth brush with a plurality of bristles surrounded by a resilient sponge body 14.

U.S. Patent Application Publication 2002/0018687 discloses a sun-screen lotion dispenser with a handle, a reservoir on one end, and a pad formed of a terry-covered sponge on the other. The lotion is pumped from the reservoir to the pad.

U.S. Pat. No. 5,240,339 discloses a body lotion applicator with a head formed of a large open-cell sponge surrounded by soft small open-cell foam.

U.S. Pat. No. 6,021,542 discloses a brush with bristles and replaceable apertured cleaning sheets.

U.S. Pat. No. 6,006,395 discloses a brush with replaceable bristles and mounted on a base.

U.S. Pat. No. 5,904,150 discloses with a perforated base receiving bristles extending from one side of the base to another and a front member with apertures receiving the bristles.

U.S. Pat. No. 6,421,872 discloses a brush with replaceable bristles.

Japanese Publication 08228822A discloses a folding brush;

U.S. Pat. No. 5,327,611 discloses a hair brush with replaceable bristles.

U.S. Pat. No. 5,247,718 discloses another hair brush with replaceable bristles.

### SUMMARY OF THE INVENTION

Briefly, the present invention is directed to a brush having a base that supports a compressible matrix and an array of bristles imbedded in the matrix and affixed to the base. As described in more detail below, in one embodiment, the base has a substantially oval or rectangular shape with two major surfaces. At least one of the surfaces supports the bristles.

In another embodiment, the base is in the shape of an elongated rod partially or completely surrounded by the matrix. In another embodiment, the brush includes a handle and a head attached to the handle, with the base, bristles and matrix forming a part of the head. As discussed in more detail below, optionally, a fluid reservoir is added in the handle for dispensing fluids either directly or through the matrix.

Preferably, the matrix compresses when brushed over the hair, partially uncovering the bristles. The amount of compression is dependent on the thickness and length of hair being groomed, the amount of force that the user applies to the brush and the structure and size of the matrix. At the end of treatment, the brush is removed from the hair and the flexible matrix bounces back to its original shape. In doing so, it lifts off loose hair strands or other materials lodged between and around the bristles during brushing, thereby providing a self-cleaning action. The user then wipes the matrix off or turns the brush upside down over a waste receptacle so that the removed materials fall off. Optionally, a low friction sheet is provided on an outer surface of the matrix to facilitate removal of the collected matter.

The matrix can be a compressible foam material or sponge that is either hydrophilic or hydrophobic. The matrix is preferably made of polyurethane but it could also be made polyether, polyester and other materials. Preferably the matrix has an open cell foam structure, although a closed cell foam or structure may be used as well. However, open cell foams are more suitable because they have good bounce-back characteristics and are softer than closed cell foams like Styrofoam. Open cell foams are often used in sponges and absorb water and water solutions, including liquid cleaners.

In one embodiment, the matrix is attached to the base that is made of either plastic or elastomeric material. The attachment may be temporary, using a detachable adhesive, a user-operated mechanical coupling or a hook-and-loop type coupling. Alternatively, the matrix is permanently attached to the base using a bonding material, or a mechanical securing element.

The bristles are integrally formed on, or attached to the base and are arranged in a two-dimensional array. The bristles are preferably oriented at a 90° angle with respect to the base.

The flexible matrix is preferably manufactured with enough bounce back in order to retain its original thickness (prior to compression) within approximately 10 seconds after it has been released. These types of materials are commonly referred to as materials having memory or “bounce back”. The foam optionally is prepunched with holes/apertures that preferably align with bristles when assembled. A common problem associated with diecutting and punching foams is that the edges of the apertures or perimeter of the diecut shape pinch together and do not release. To solve this problem, foam manufacturers change the formulation of the foam creating a “clickable” foam—a foam material with edges that release during the punching or diecutting process.

The flexible matrix is optionally covered with scrim netting or other suitable materials that have a continuous, open structure, such as synthetic and wire mesh screens. The use of a scrim netting or mesh screen creates a slippery surface during use of the inventive brush, thereby promoting the brushing action. Other materials to cover the foam matrix, and also for creating integrity of the flexible matrix (to make sure it remains intact during active and repeated use), and for promoting “slip” (to prevent hair from sticking to the head of the flexible foam matrix) as well, are expandable inks, varnish and silicone. Still other materials to cover the foam matrix can be stiff to spread the deflection point over a greater area. Still other materials such as friction activated perfumes known in the art as “scratch & sniff” technology, and hair treatment can optionally be affixed to the foam and/or scrim or top layer to engage hair, skin, coat and deliver same.

Synthetics (and non-synthetic fabrics such as cotton), such as polyolefins (i.e., polyethylene and polypropylene), polyesters, polyamides, synthetic celluloses (i.e., rayon), and blends thereof may be applied over the flexible matrix to also promote, “slip” and to provide absorbency characteristics. Such fabric materials (i.e., non-wovens) may be manufactured using known processes such as carded, spunbond, melt blown, airlaid, needle punched and the like. Such materials may be applied to the flexible foam matrix by lamination or coating processes, such as flexographic or spray applications.

A brush constructed in accordance with this invention can be used for either wet or dry applications. Dry applications include dry cleansing operations in which materials are removed from hair or skin without any fluids.

Wet applications involve exposing the hair, skin or scalp to a fluid and then removing at least some of the fluid and other materials with the brush. For this option, a moisture absorbent or a hydrophilic foam is preferred while for dry applications a hydrophobic foam is preferred.

More particularly, for wet applications, the flexible sponge matrix is disposed on the head of the inventive brush that is wetted with desired cleaning chemicals, typically in one of three ways: by providing a pre-moistened sponge, by delivering the cleaning chemicals from a storage reservoir in the handle to the sponge, and/or by pre-spraying the skin or hair with the chemicals so that the flexible matrix absorbs and spreads the material.

For the wet/moist brush option, in order to clean the scalp, ears, face or skin prior to using the brush (prior to hair or fur grooming), the brush is moved gently over the respective body areas using modest pressure so that the flexible foam matrix does not compress and expose the bristles. Exposing the bristles creates a rough undesirable feel to the skin of an animal, or to the face and/or scalp of a human. The flexible matrix will release and deliver chemicals as it is applied across the skin, as discussed before.

Thereafter, and in order to clean and comb hair and/or remove loose, dead hair, more pressure is used to compress the flexible matrix, thereby engaging the bristles in order to separate and engage the hair and scalp.

In one embodiment, the brush includes a handle and a separate head that can be selectively attached and removed from the handle. The head includes a base, bristles arranged in an array on the base, and the matrix surrounding the bristles. The matrix can be permanently attached to the base, or may be removable. Heads of different shapes or sizes can be used for different purposes, include dry and wet treatments discussed above.

In one embodiment, the brush can be used not only for cleansing hygienic purposes but for other treatments as well. For example, the brush may be used to massage the scalp or skin. For this purpose, a self-sufficient vibrating device is disposed in the brush, the device including a battery, a motor with an eccentric counterweight and a control switch operable to initiate vibration. In one embodiment of the invention, the battery and switch are disposed in the handle while the motor is disposed in the head. In another embodiment the while vibrating device is disposed in the handle.

### DESCRIPTION OF THE DRAWINGS

FIG. 1 is a front elevational view of a first embodiment of the inventive brush device;

FIG. 2 is a side elevational view of the brush of FIG. 1;

FIG. 3 is an enlarged side view of the handle for the brush of FIGS. 1 and 2, with details of an optional trigger pump;

FIG. 4 is a side view of a second embodiment of the invention showing a brush head with a portion of the flexible matrix being recessed;

FIG. 5 is a side view of an alternate embodiment of the brush of FIG. 4;

FIG. 6 is a side view of another embodiment of the brush of FIG. 4;

FIG. 7 is a perspective view of a head or cartridge with the matrix in a relaxed state, constructed in accordance with this invention;

FIG. 8 shows the head of FIG. 7 with the flexible matrix being in a compressed condition with hair lodged in the bristles;

FIG. 9 shows another embodiment of the head in which head is substantially surrounded by the flexible matrix;

FIG. 10 is a front elevational view depicting a handle receiving the head of FIGS. 7-9 and a spray dispenser as an option;

FIG. 11 is a front elevational view depicting a handle receiving the head of FIGS. 7-9 and a squeezable dispenser as a handle option;

FIG. 12 is a front elevational view depicting a handle receiving the head of FIGS. 7-9 and a trigger plunger for the dispenser;

FIG. 13 is a front elevational view depicting a decorative handle receiving the head of FIGS. 7-9 with a hang hole;

FIG. 14 is a front elevational view of a hinge handle with an optional finger hole;

FIG. 15 is a front elevational view of another version of a bristle head or cartridge, with a flexible matrix mounted thereon, said matrix being provided with one or more layers to render the matrix impenetrable impermeable to water and/or said additional layers to add stiffness to spread the deflection point over a greater area;

FIG. 15A shows a cross-section view of the embodiment of FIG. 15;

FIG. 15B shows a cross-sectional view of an alternate FIG. 2;

FIG. 16 is a front elevational view of the head with the matrix being compressed;

FIG. 17 shows a front elevational view of the base and the bristles mounted thereon;

FIG. 18 is a front elevational view of one embodiment of the brush handle to be used with the bristle cartridge shown in FIGS. 15, 15A, 16 and 17;

FIG. 19 is a rear view of the back of one version of the head of FIG. 15 and how it slides into position;

FIG. 20 is a rear view showing the back of another version of the head of FIG. 15 and how it locks onto the handle;

FIG. 21 is a front elevational view of a another of the brush handle to be used with the bristle cartridge shown in FIG. 15;

FIG. 22 is a partial front elevational view similar to FIG. 21 and showing an alternative handle design;

FIG. 23 is a front elevational view similar to FIG. 21 and showing a third handle design;

FIG. 24 is a side elevational view of yet another version of the invention;

FIG. 25 is a side elevational view similar to FIG. 24, but showing the flexible matrix in a compressed condition;

FIG. 26 is a side elevational view of a handle using the brush head of FIG. 24;

FIG. 27 is a side elevational view similar to FIG. 26 and showing attachment of the brush head of FIG. 24 to the handle;

FIG. 28 is a side elevational view of another embodiment of the invention that relates to a two part configuration with the brush in an open active;

FIG. 29 is a cross-sectional view of the brush depicted in FIG. 28 in a closed storage condition;

FIG. 30 is a side elevational view of another version of the embodiment of FIG. 28 with the brush in an open active condition;

FIG. 31 is a cross sectional view of the brush depicted in FIG. 30 in a closed storage condition;

FIG. 32 is a side elevational view of an embodiment in an open active condition, the embodiment being similar to the one in FIGS. 28 and 29 but with a covered matrix;

FIG. 33 is a side sectional view of the brush in FIG. 32 in the closed position;

FIG. 34 is a top plan view of the brush depicted in FIG. 28;

FIG. 35 is a bottom plan view of the brush depicted in FIG. 30;

FIG. 36 is a side plan view of the brush depicted in FIG. 34 with a “pick” style handle;

FIG. 37 shows a sectional view of a first alternate embodiment of the brush depicted in FIG. 18;

FIG. 38 shows a sectional view of a second alternate embodiment of the bush depicted in FIG. 18;

FIG. 39 shows a plan view of a cap of the embodiments of FIG. 37 or 38;

FIG. 40 shows a sectional view of a first alternate embodiment of the brush depicted in FIG. 14;

FIG. 41 shows a sectional view of a second alternate embodiment of the brush depicted in FIG. 14;

FIG. 42 shows a plan view of a cap of the embodiments of FIG. 40 or 41;

FIG. 43 shows a blown-up sectional view of another embodiment of the brush;

FIG. 44 shows a side view of the embodiment of FIG. 43;

FIG. 45 shows an end view of the embodiment of FIG. 44;

FIG. 46 shows a plan view of a cap for the embodiment of FIGS. 43-45;

FIG. 47 shows a side view of another embodiment of the brush;

FIG. 48 shows a sectional back view of the brush of FIG. 47;

FIG. 49 shows a back view of the brush of FIG. 47;

FIG. 50 shows a front view of the brush of FIG. 47;

FIG. 51 shows a side view of a head for the brush of FIG. 47;

FIG. 52 shows a side view of the head of FIG. 47 with matrix compressed.

FIG. 53 shows a back view of the head of FIGS. 51 and 52.

### DETAILED DESCRIPTION OF THE INVENTION

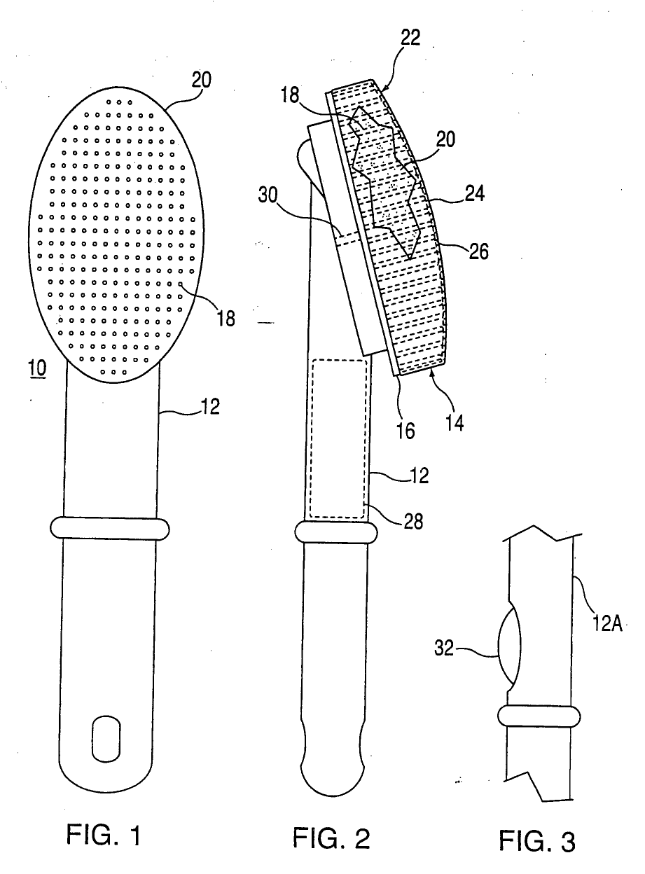

In one embodiment shown in FIGS. 1-3, the inventive brush 10 includes a traditional brush handle 12 and a brush head 14 attached to the handle 12. The brush head 14 includes a base 16 made of a plastic or rubber material, a plurality of bristles 18 and a flexible matrix 20. The bristles 18 can be made of a rubber, an elastomeric or plastic material, or a rigid plastic such as polyethylene or polypropylene or combination thereof.

The bristles may be attached to the base 16, but preferably the base 16 and the bristles 18 are made as a unitary member using molding or other well-known techniques. The flexible matrix 20 is sized and shaped to surround the bristles 18. Preferably, the bristles extend to a height selected so that they terminate below a surface 22 of the matrix by a predetermined amount, e.g. 1/32″. The matrix 20 can be made of a clickable foam or a sponge. Optionally, a sheet 24 with holes or perforations 26 is wrapped around the matrix 20 as shown. The holes 26 are distributed to match the distribution of the bristles 18 and are sized and shaped to allow the bristles to move in or out of the matrix and through sheet 24.

The sheet 24 may be made of silicone, varnish, plastic film, rigid plastic sheeting, scrim or a thermoplastic film lamination coating. Preferably, the sheet 24 is provided to facilitate cleaning of the skin or scalp as well to facilitate easy cleaning/separation of the hair from the brush, as described below. The sheet 24 also provides structural support to the matrix 20 and in this manner it also protects and maintains integrity of the matrix thereby prolonging the useful life of the brush.

The sheet 24 forms a non-sticky low friction contact surface as the brush is applied. Therefore the sheet 24 makes the brush 10 easier to use, with less chance of pulling the hair or scrapping the skin.

In FIGS. 1 and 2 the sheet 24 is wrapped around the matrix 20, however, it may be shaped so that it covers only a portion (for example 5% or more) of the surface 22.

The sheet 24 may be made of various natural and artificial materials and may be formed as a plastic film, lamination, scrim coating or combination thereof. The sheet 24 may be made of a non-woven fabric substrate such as synthetics (for example, polyethylene and polypropylene, polyesters, polyamides, synthetic celluloses) and blends thereof blends such as 45% Tencel/55% Polypropylene (preferably without a binder). These synthetic materials may be manufactured using known processes such as carded, spunbond, melt blown, air laid and needle punched. Alternatively, the sheet 24 may be made of a natural material such a water-absorbent cotton.

In one embodiment, the handle 12 is hollow, or alternatively, it is solid. In another embodiment, the handle is formed with a reservoir 28 filled with water/hair and/or scalp treatment fluid. In one embodiment, the handle is somewhat soft and resilient and squeezing it causes the fluid to be expressed from the reservoir into the matrix 20 through one or more apertures 30.

In another embodiment, a handle 1 2A is provided for the brush 10 that includes reservoir 28 and has a hand-operated trigger pump 32, as shown in FIG. 3. Activating the trigger pump 32 with a thumb causes the fluid from the reservoir 28 to be expressed into the matrix 20.

In use, the matrix 20 is disposed over the bristles 18 and is flexible so that it compresses as the brush is applied to and passed over hair or fur. As a result of this compression, the bristles 18 extend out of the matrix 20 by an amount based upon the thickness of the hair or fur. As the brush passes over the hair or fur, extraneous hair, fur, skin flakes or foreign matter is removed, and some or all of this material collects between or gets wrapped around the bristles 18.

As soon as the brush 10 is removed from the scalp of a person or the body of an animal, the resiliency of the matrix 20 causes it to rebound to the position shown in FIGS. 1 and 2. As a result, the bristles 18 retract into the matrix 20 leaving the collected materials on surface 22. The collected material is then easily disposed by tipping or turning the brush over. The optional sheet 24 insures that the brush glides over the hair or fur easily, and that the collected material separates more readily then if a bare matrix 20 is used.

One skilled in the art will recognize that the brush 10 is a self-cleaning brush which automatically adjusts to the hair length or depth because of the compression of the flexible foam matrix. As a result, no extra knobs, buttons, pull points, cages, or rubber mats are required to remove the hair, fur or other collected materials from the bristles such as found in traditional self-cleaning brushes.

In one embodiment, the brush 10 is made and sold as a single unitary tool. In an alternate embodiment, the head 14 is made as a disposable unit that is removably attached to the handle 12 by standard means. The head can then be prepackaged and sold separately from the handle and can be replaced at will.

Alternatively, some of the elements of the head are replaceable. For example, the base 16 can be permanently mounted on the handle 12 and the matrix 20 is secured to the base using an adhesive (not shown) that is tacky enough to hold the matrix 20 in place on the base, but allows the matrix to be pulled off relatively easily. Other means for affixing the matrix 20 to the base 16 can be used as well, including using a hook-and-loop fastener or other similar fasteners.

In this latter embodiment, one or more matrices 20 can be distributed in separated packages to users. Each package may include several matrices of different color and/or physical characteristics, or dimensions. Moreover, each package may include separate sheets 24 as well.

Producing a refillable, replaceable flexible foam matrix 20 with, or without the head 12 is important in that it renders the whole brush 10 reusable. The attachment means for attaching the matrix 20 to the base, or the head to the handle 12 may also feature an enhanced transportation mechanism to move any cleaning, conditioning, and medicating liquid from the brush handle reservoir to the flexible matrix.

Preferably, the brush 10 is used for animals—large, medium, and small, and can be sized appropriately. An alternate use is for bedridden people—older patients that are bedridden tend to have thinner skin/scalp. They can control the amount of bristle/scratch they need by varying the pressure exerted on the head. Additionally, on-the-go, hurried men and women who want a styling product or refresher to use throughout the day will utilize the inventive brush as well.

The flexible matrix 20 is preferably pre-die cut with the indents or openings to receive the bristles. The matrix must have the proper density and possess proper “memory” so as to return to its original shape within approximately 10 seconds after the brush is removed in order to promote the quick removal of entangled hair and other materials. This insures that the user does not have to wait for the brush to clean itself. Therefore, the matrix 20 is made of a foam that has an Internal Load Deflection “ILD” (a known industry standard) in the range of approximately 15-60 ILD. The preferred range is 20-30 ILD.

Density is also important for the foam used as a matrix in the inventive brush. A density range of 40% polymer or more (by volume) is preferred.

Importantly, the inventive brush does not require the manual removal of a rubber mat, the picking of hair out of bristles, or the pushing of buttons to release a “rack” so as to remove hair. The inventive brush is also capable of cleansing, conditioning and medicating the hair and scalp.

In one embodiment of the invention, the sheet 24 accordance with the invention, providing a top layer for the wet/moist brush option in order to facilitate cleaning of the skin, ears, and/or body parts prior to applying compression to the flexible matrix renders the inventive brush even more advantageous.

FIGS. 4-6 show another embodiment of the invention. In this embodiment, a brush 110 is provided with a base 116 having a plurality of bristles 118 arranged in a two-dimensional pattern. In this case, since no handle is provided, the base is made somewhat thicker to form a block that can be grasped with a hand. The base 116 can be formed with detents, as at 117 to facilitate holding the brush 110. Matrix 120 is attached to base 116 by a fastening member 119. This fastening member may be a member that secures the matrix 120 permanently. For example, the fastening member may be a layer of hard-setting glue.

Alternatively, the fastening member may be a releasable member that allows the matrix 120 to be removed several times, or allows the matrix 120 to be replaced completely. Thus, fastening member 119 may be a layer of releasable glue, a hook-and-loop fastener, a mechanical element, and so on.

The matrix 120 is partially recessed. For this purpose, the matrix is provided with an outer surface 122 that is optionally covered with a sheet 124. The matrix 120 and the optional sheet 124 are formed with holes or apertures 126 receiving the bristles 118. Importantly, while in the embodiment of FIGS. 1 and 2, the surface 22 of the matrix is generally planar, surface 122 is formed with two sections: a section 122A that is disposed at a constant preset distance from the base 116, normally determined by the length of the bristles 118, and a section 122B that is disposed closer to the base 116 thereby exposing a number of the bristles 118. Section 122B is preferably curved, as shown in the figure. In order to obtain this shape, the matrix 120 is can be cut into the shape shown in the Figure, in which case, it has a uniform density. Alternatively, a portion of the matrix 120 disposed between section 122B and the base 116 can be pre-compressed and set into the curved shape.

In the embodiment of FIG. 4, the brush 110 is used without ejecting any liquid from the brush-that is, in a dry mode. For this mode, the sheet 124 can be made from a dry plastic film, a rigid film, a water resistant paper or foil, to make it easy for a user to peel off the hair or other materials. Instead of a sheet, a coating of an expandable ink, friction activated perfume coating, varnish and other materials may also be used. The matrix can be made from polyethylene, polypropylene, PVC and so on.

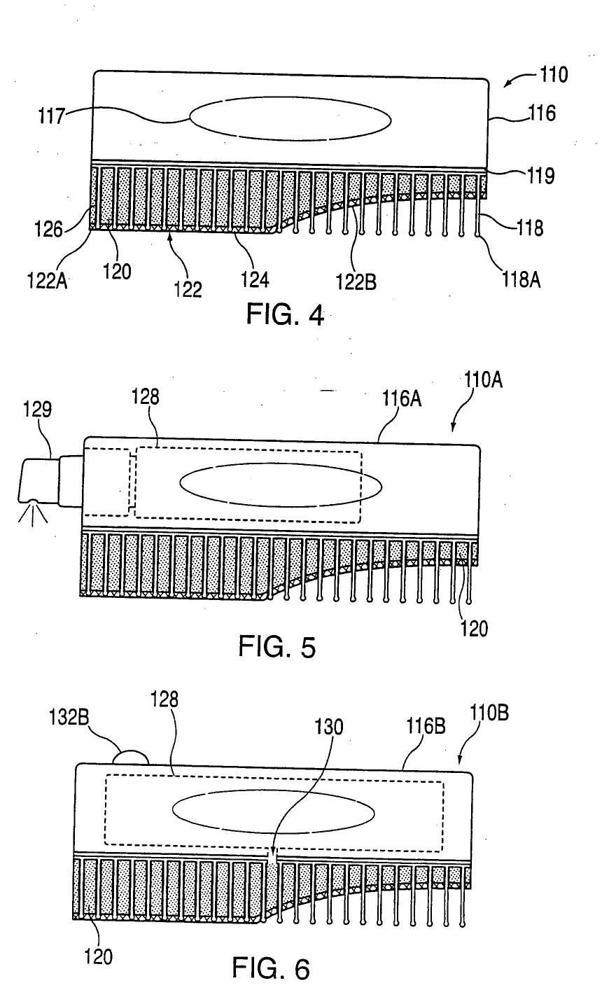

In alternative embodiment, the brush 110 may be modified to include a liquid reservoir. In the embodiment shown in FIG. 5, the brush 110A has a base 116A with a reservoir 128 and a spray head 129. The reservoir 128 may hold a soap solution or other cleansing fluids. The fluid is dispensed through spray head 129. The embodiment of FIG. 5 may be implemented by providing the base 11 6A with a cavity that holds a standard bottle with spray head 129.

In another alternative embodiment shown in FIG. 6, a brush 110B has a base 116B formed with a reservoir 128. A hole 130 provides a fluid conduit from the reservoir 128 to matrix 120. The reservoir is filled with a liquid and a trigger pump 132B is mounted on the base 116B. The trigger pump is used to eject the liquid into the matrix 120. In this embodiment, the brush can be pre-moistened before use, and can be used for various types of washing and cleaning, including rinsing the scalp, washing the ears, hair and body parts.

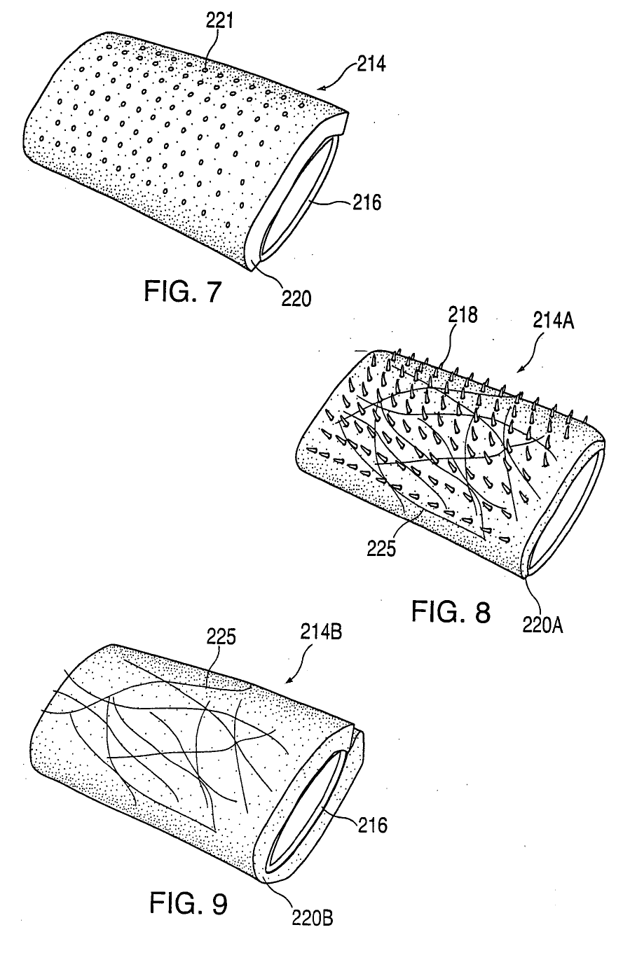

FIGS. 7-14 show another embodiment of the invention. In this embodiment, several different types of brushes use the same replaceable head or cartridge 214. As shown in FIGS. 7-9, the head 214 includes a hollow base 216 with an elliptical cross-section. An arcuate matrix 220 is affixed to the base 216 using an adhesive, a thermal bonding fastener or a mechanical fastener. The matrix 220 is formed with apertures 226 receiving bristles 218 attached to the base 216.

Like in previous embodiment, in use the matrix 220 is compressed by the hair or fur thereby exposing the bristles 218. The bristles pick up loose hair 225 or other materials. When the brush is removed from the body, the matrix 220 naturally decompresses or relaxes thereby removing the materials 225 from the bristles 218, as shown in FIG. 9.

In the embodiment shown in FIGS. 7 and 8, the matrix 220 is shaped and sized to cover one of the two major surfaces of the base 216. Preferably, in this embodiment the matrix 220 covers circumferentially slightly more than half of the base 216. FIG. 8 shows a slightly different head or cartridge 214A having a a base 216 and a matrix 220A that completely surrounds the base 216. In another embodiment, the matrix is shaped as a sleeve that fits over the base 216 without a peripheral gap.

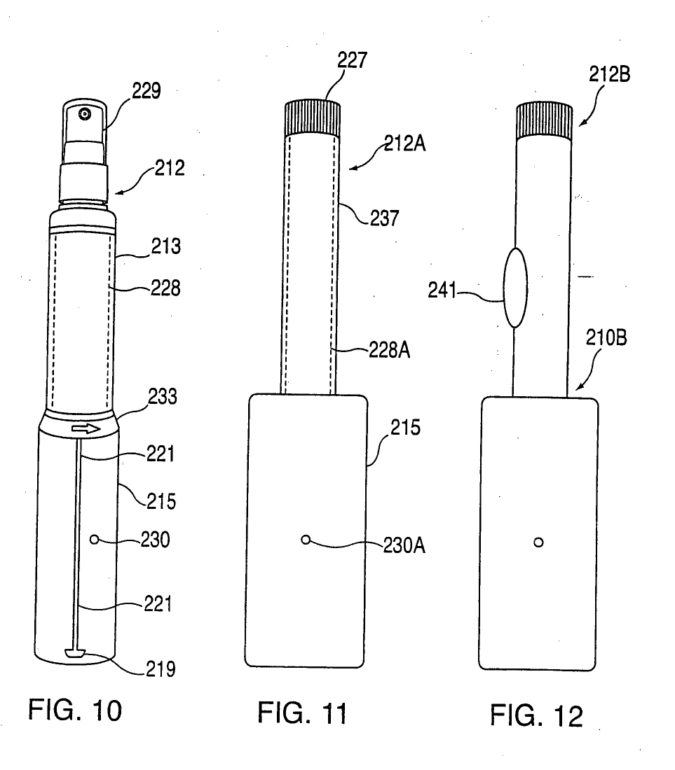

FIGS. 10-14 show different handles that accept the head or cartridge 214, 214A thereby forming a corresponding brush. FIG. 10 shows a handle 212 having a top portion 213 terminating with a spray head 229 and a bottom portion 215 that is coaxial with the top portion 213. The handle 212 is formed with a reservoir 228 which can be filled with liquid. The contents of the reservoir 228 are dispensed by the spray head 229.

One or more holes 230 may be provided in the bottom portion 215, said hole being connected to the reservoir 228 so that the contents of the reservoir 228 may be dispensed through the hole 230 and through a corresponding hole in the head 218 into the matrix 220.

The outer surface of the lower portion 215 is sized and shaped to receive thereon the cartridge 214 or 214A. The cartridge is positioned by passing over the bottom nib portion 219 and then locks into the bottom portion support section 215 with the edge of the cartridge abutting the collar 233. Once one of the cartridges 214, 214A is positioned on the handle 212. The resulting brush is then used in the normal fashion to remove hair and other materials, and/or to apply liquid from reservoir 228 through the hole 230 (if provided). When a liquid shut off is required, the head 214 is rotated to disengage the hole in the reservoir 233 with the hole in the cartridge realigning the hole 230 with a solid portion of the cartridge 214 or 214A. A new head can now be installed.

The embodiment of FIG. 11 includes a handle 212A with a top portion 213A and a bottom portion 215A having a hole 230A. The bottom portion has a structure similar to structure 215 described above. The top portion 213A includes a rather elongated member 237 forming the reservoir 228A. The reservoir is closed by a cap 227. The sidewalls of the member 237 are flexible. When these sidewalls are flexed, a fluid from the reservoir 226A is expressed through the hole 230A into the matrix (not shown). Cap 227 may be removed to fill the reservoir 228A.

The embodiment of FIG. 12 is very similar to the one in FIG. 11, with the exception that instead of making the sidewalls of member 237 flexible, a rubber plunger 241 is provided for expressing the contents of the reservoir.

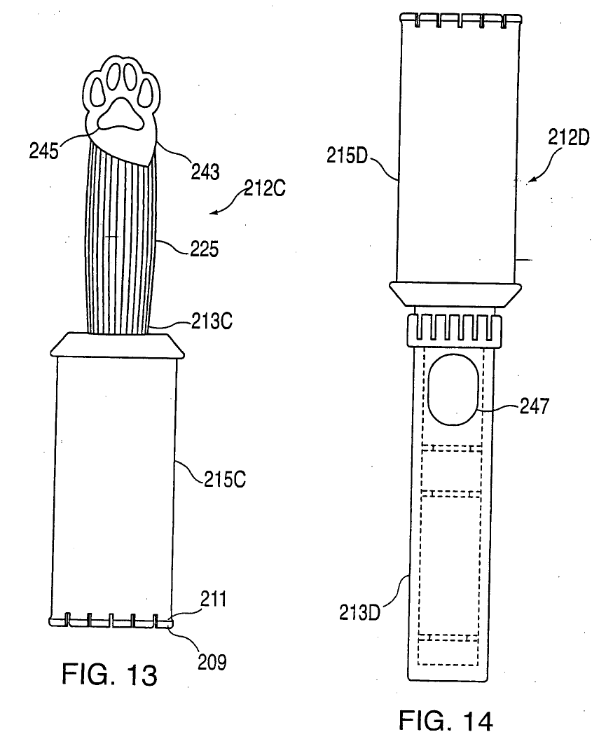

The handle 212C of FIG. 13 has a top portion 213C that is fluted as at 225 to make the handle easier to grasp. The top portion is also formed with a flat section 243 that may be used for a decorative design. A hole 245 may be provided in this flat portion that may be used as a means of hanging the handle 212C.

The bottom portion 215C is provided at its bottom with a scalloped edge 211. The edge 211 includes a rim 209 that extends axially outwardly of the outer surface of portion 215C and is axially flexible in the inward direction. The cartridge 216 or 216A is installed on bottom portion 215C by pushing the cartridge over the nibs 209. The ribs 209 then trap the cartridge on the bottom portion 215C.

FIG. 14 shows another handle 212D in the inverted position. This handle has one portion 215D similar to portion 215C and a second portion 213D that is formed with an optional hole 247. The hole 247 is shaped and sized to accept the finger of a user of the brush. The purpose of the hole is to provide an opening to insert the index finger and depress a pump or aerosol top during use. The portion 213D may hold a spray bottle or aerosol can known to those skilled in the art. Importantly, the portion 215D and the 213D are optionally connected by a hinge that allows the two portions to rotate with respect to each other. The hinge has a locking position in which the two portions are axially aligned. Said hinges commonly used and known to those skilled in the art combine metal pins threaded through a channel in both aforementioned parts or plastic pin integral with top or bottom part and receiving aperture in companion part. The brush in the folded position is easier to store in a pocketbook, medicine cabinet, drawer, etc.

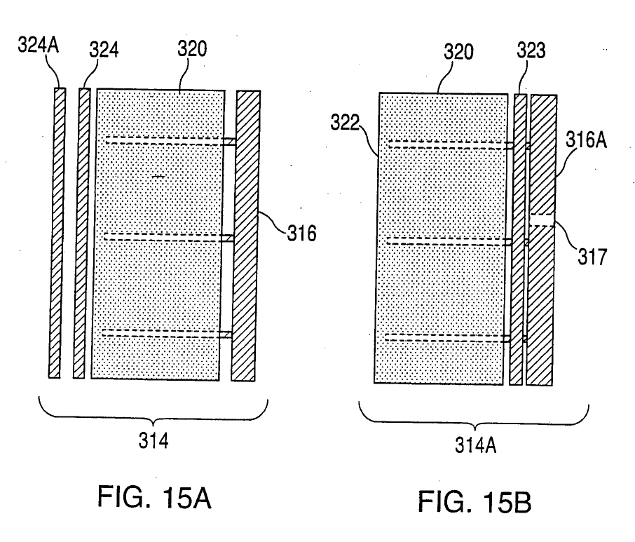

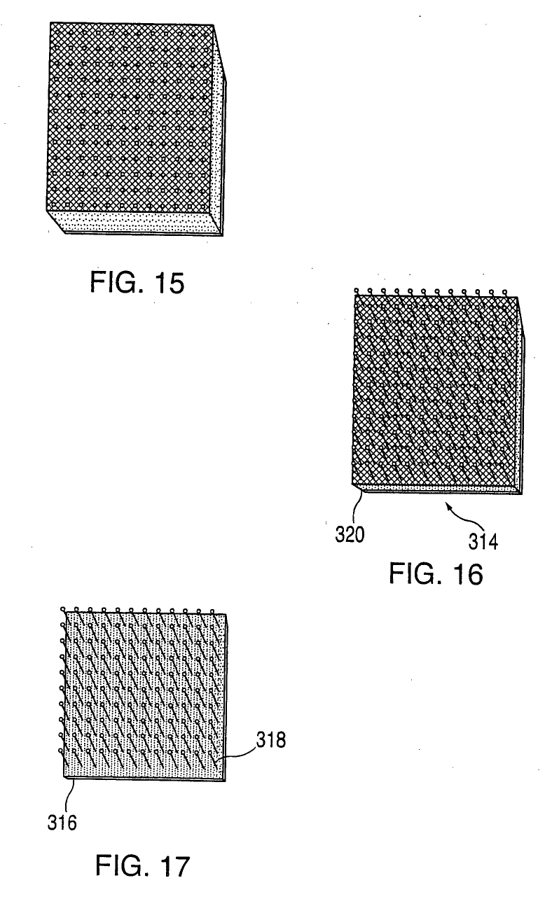

FIGS. 15-17 show another embodiment of a brush head constructed in accordance with this invention. In this embodiment, a head 314 is provided that is formed of a plastic base 316 with bristles 318. The head 314 and other elements are shown as having a generally square shape for the sake of simplicity, however other shape can be used as well. A matrix 320 is positioned over the base 316 with the bristles 318 being embedded within. In one configuration, the head 314 is used only for dry applications, i.e., without applying a liquid to the hair or fur. For this embodiment, a sheet 324 is provided on the sponge that is made of a dry plastic film. Optionally, an additional component 324A is added to the layer 324. This additional component 324A could be a thin silicone coating and/or a woven mesh or scrim or stiffer layer of elastomeric material or foam and can include a friction activated perfume coating. The two layers 324, 324A cooperate to facilitate the removal of hair, fur and other materials collected or trapped between the bristles 318. The layer 324A keeps moisture away from the matrix 320. The matrix 320 and layers 324, 324A are formed with holes 326 to allow the bristles 318 to exit as the matrix 320 is compressed. In the case of a stiff top layer said layer used to make processing and punching of small ⅛′ and less diameter apertures possible in addition to spreading the deflection point.

The alternate configuration shown in FIG. 25B and it consists of an outer layer 324B formed of a material that is water permeable. For example, layer 324B may be a non-woven fabric. The head 314A may also include a liquid dispensing layer through which a cleansing solution such as liquid soap and the like is dispersed through the matrix 320 from a hole. 317. The liquid is used to wash the hair, fur, skin or scalp.

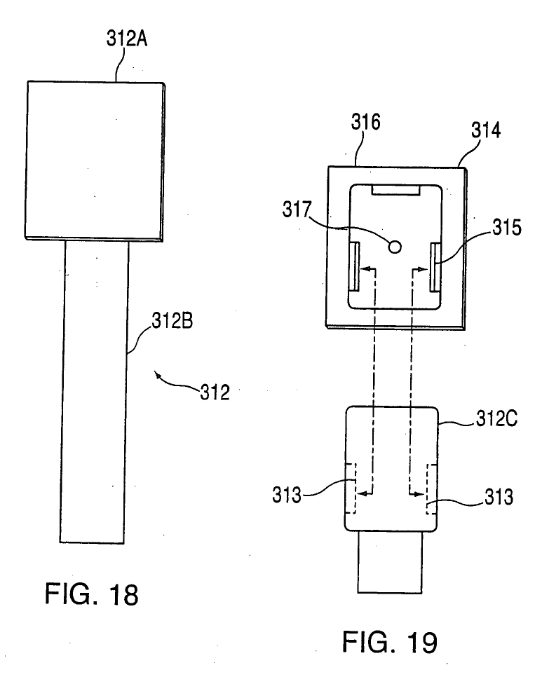

As shown in FIG. 18, handle 312 includes a top portion 312A and a bottom portion 312B. Top portion 312A is provided to engage and secure the head 316. This can be implemented in many different ways. For example, as shown in FIG. 19, the portion 312A can be formed with a plurality of indentations 313 and the head 314 is provided with matching clips 315. The head 314 is then attached to the top portion 312A by the engagement of the clips 315 with indentations 313. As discussed above, for a wet configuration, aperture 317 is provided as an egress means of inserting fluid into the head astle.

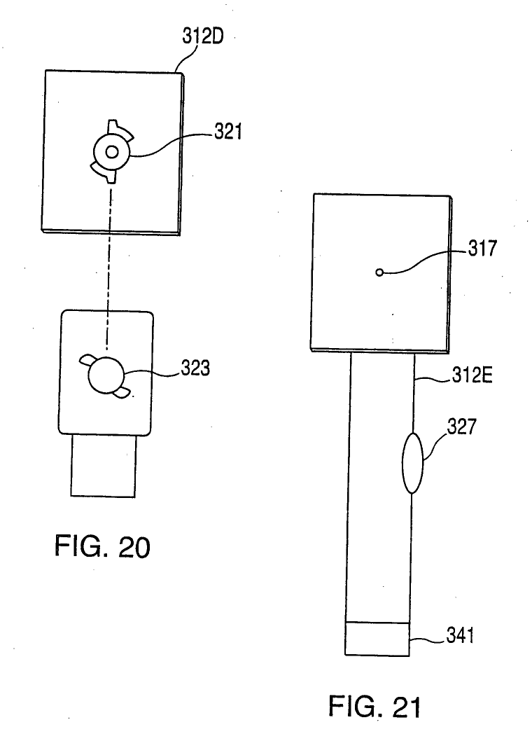

In an alternate embodiment shown in FIG. 20. Base 316C is formed with a boss 321 and the upper portion 312C is formed with an aperture 323 for trapping boss 321 to couple the two parts together. The aperture 323 and the boss cooperate so that when the boss 321 is inserted into the aperture 323 and then rotated, for example by 90 degrees, the base 314 is locked on the upper portion 312D.

As discussed above, the subject brushes could be used for both wet and dry applications. The configurations shown in FIGS. 18 and 20 are used for dry applications together with the head of FIGS. 15, 15A, 16, 17 and no liquid reservoir is provided in the handle 312.

The configurations of FIGS. 19, 21, 22 and 23 can be used for wet applications together with the heads of FIGS. 15B and 19.

In the configuration of FIG. 21, the handle 312E is formed with a reservoir holding a liquid. The reservoir is closed by a cap 341 and a plunger 327 is used to pump the liquid to the head.

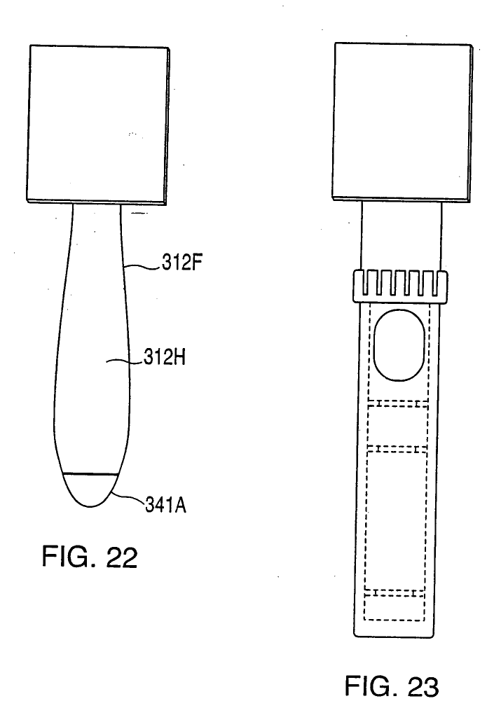

In the configuration of FIG. 22 the lower portion 312F forms a reservoir with a cap 341A and is made of a soft material that can be squeezed to pump the liquid to the head.

The configuration of FIG. 23 is a folding brush configuration similar to the one shown in FIG. 14.

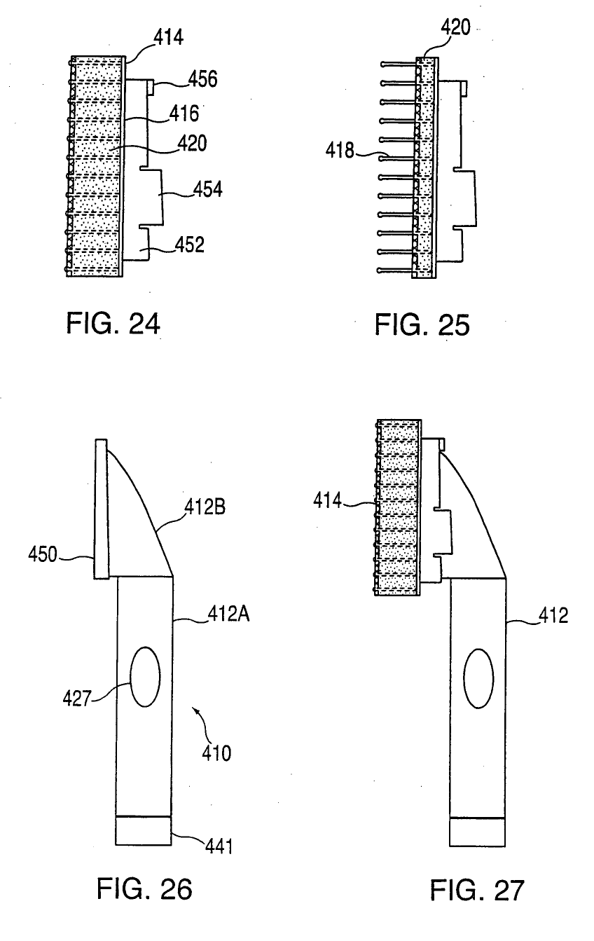

FIGS. 24-27 show another configuration of the invention. In this configuration, a brush 410 is shown with a handle 412 and a head 414. The handle includes a top portion 412A and a bottom portion 412B. The top portion 412A includes a neck terminating in a vertical rim 450. The handle 412 may include a liquid reservoir, in which case the reservoir is closed by a top 441 and its contents are displaced by a plunger 427.

Head 414 includes a base 416 with bristles 418 imbedded in a matrix 420. In use, the matrix 420 is compressed, as shown in FIG. 25, thereby exposing the bristles 418.

The base 416 is provided with a circumferential sidewall 452. The sidewall is made formed with a tab 454 and a stop 456. As shown in the Figures, the head 414 and the handle 412 are configured so that the head 414 slips over the rim 450 of the handle thereby forming an interference fit that keeps the head 414 in place during use. The downward movement of the head 414 is limited by the stop 452. After multiple uses, the head 414, or at least its matrix 420 can be replaced.

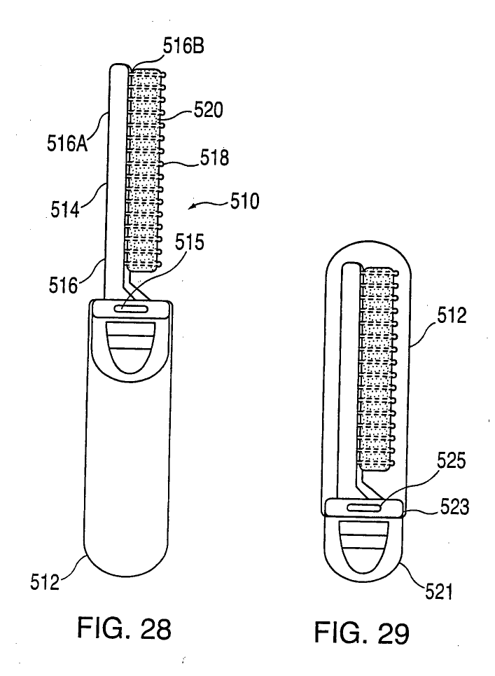

FIGS. 28-35 show another embodiment of the invention wherein the brush is disposed in a storage case. Brush 510 includes a handle 512 that is hollow and is formed with a neck 513 having a transversal hole 515.

Attached to the handle 512 is a head 514 having a flat elongated base 516 with two opposed surfaces 516A, 516B. A plurality of bristles 518 depend from and extend perpendicularly from surface 516B as shown. The bristles 518 are embedded in a flexible matrix 520 having the characteristics described above. As seen in FIG. 29, base 516 includes a neck 523 with a transversal rib 525 having a complementary shape to hole 515.

The two elements 512, 514 of brush 510 can be engaged in two positions. In the open position shown in FIG. 28 the handle 512 and brush head 514 are coextensive. Engagement between the parts is provided by the interference fit between necks 523 and 513. In this position the rib 525 snaps into hole 515 to insure that the two elements stayed in a locked position in use. Once a customer finishes using the brush 510, he pulls up on the brush head 514 to disengage the necks 513, 523. The customer then reverses the head and inserts it into the handle as shown to form the storage configuration.

The matrix 520 remains on the bristles 518 until it is replaced.

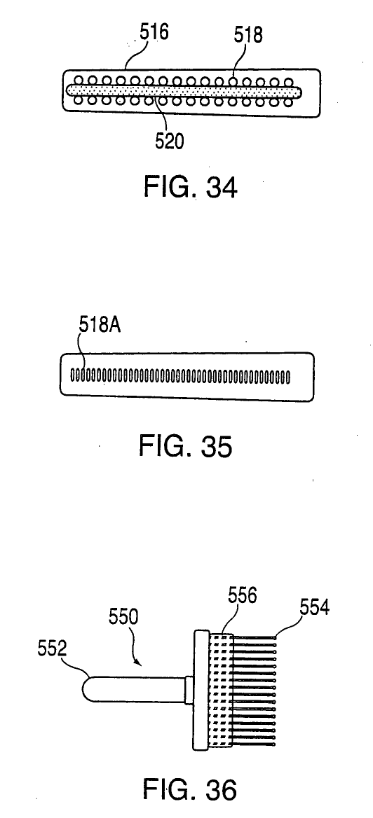

Preferably, as shown in FIG. 34, the bristles 518 are disposed in two parallel rows along the longitudinal axis of the base 514. The matrix 520 is then wedged between the two bristles rows as shown,

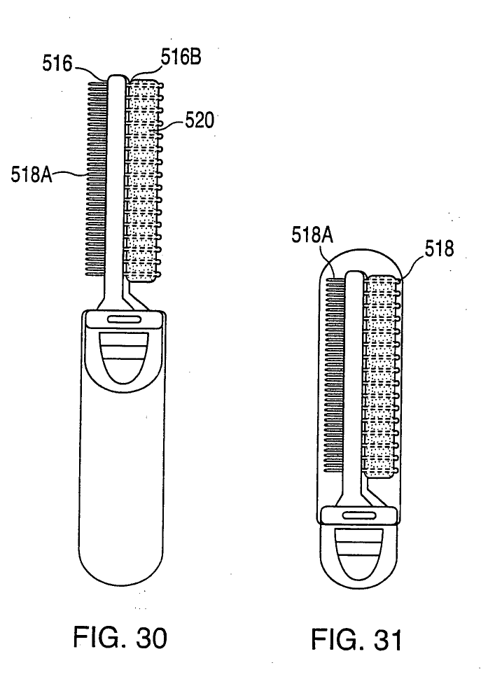

FIGS. 30 and 31 show an arrangement similar to the one in FIGS. 28 and 29 however, in this brush 510A the base 516 has on surface 516A a set of secondary bristles forming a comb 518A. As shown in FIG. 35, the comb bristles forming comb 518A are arranged in a single row.

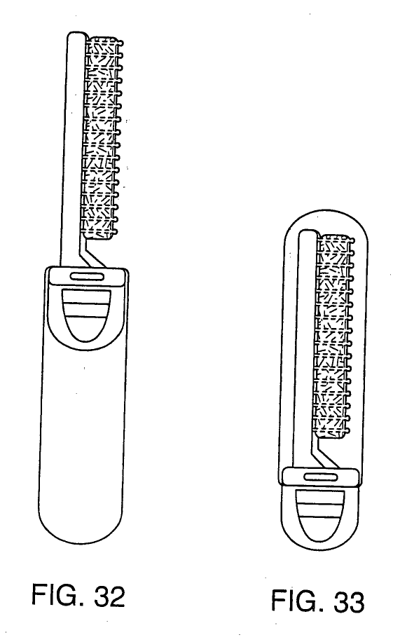

FIGS. 32 and 33 discloses a brush similar to the ones in FIGS. 28, but instead of an open matrix 520, an absorbent matrix 520A. Matrix 520A can be made of various materials, including non-woven materials, sponges, foam, Porex®, open cell polyurethane, hydrophilic or hydrophobic materials, and son on. The matrix 520A can be moistened and used for various cleansing , hair and scalp treatment operations.

FIG. 36 shows another embodiment of the invention in which a brush 550 is provided in form of a pick with a handle 552 and a plurality of bristles 554 and a matrix 556. Preferably matrix 556 is a compressible foam matrix positioned to cover up to 25% of at least the bristles. The bristles are preferably plastic tooth, optionally elastomeric with a slit between said teeth to accommodate the teeth as they move and flex through kinky, coarse hair.

The brushes described herein are used for cleaning and personal hygiene as well and may include additional features and components that can be used to providing various types of treatment and promoting well being. For example, it is well known that massaging the skin and scalp has various benefits and therefore, the brushes described below incorporate elements that provide selectively vibration functions.

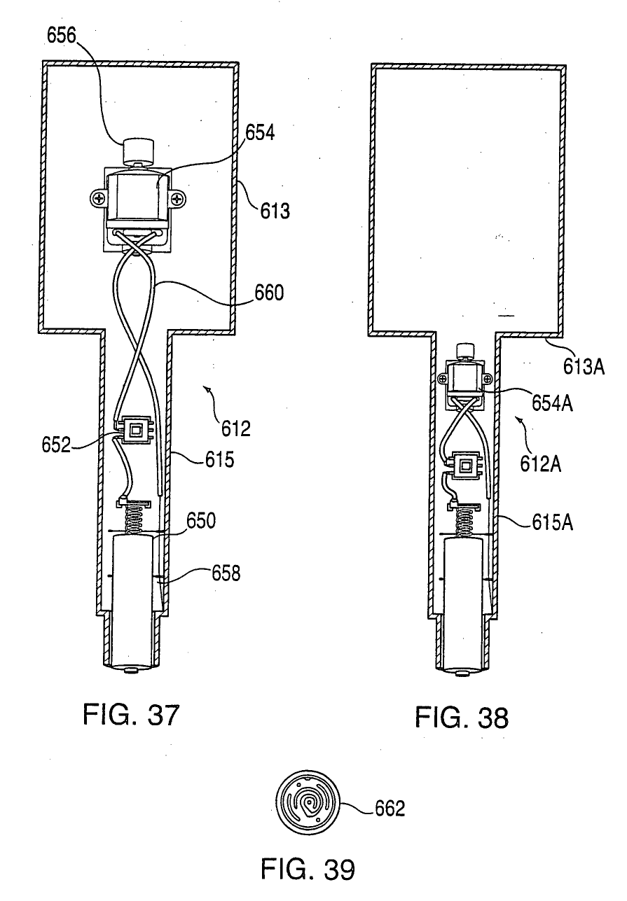

In FIG. 37 a brush handle 612 is shown having the same structure as the brush handle of FIG. 18. The brush handle 612 includes a top portion 613 and a bottom portion 615. The top portion 613 is constructed and arranged to receive a fixed or replaceable brush head (not shown) with bristles and a matrix similar to the one shown in FIGS. 15-17. The bottom portion 615 has a generally cylindrical shape and it houses a battery 650, an activating switch 652, a motor 654 with a rotating axis for turning a counterweight 656. The counterweight 656 is off-balance so that its rotation causes the brush to vibrate. When the switch 652 is closed, current from battery 650 flows through conventional wires 660 to activate the motor 654. In the embodiment of FIG. 37 the motor 654 is disposed in the top portion 613. The battery 650 is disposed in a compartment 658 formed in bottom portion 615 and closed by a cap 662.

FIG. 38 shows a cross-sectional view of a brush handle 612A very similar to brush handle 612 and receives the same type of brush head. The only difference is that motor 654A is disposed in bottom portion 615A rather than top portion 613A.

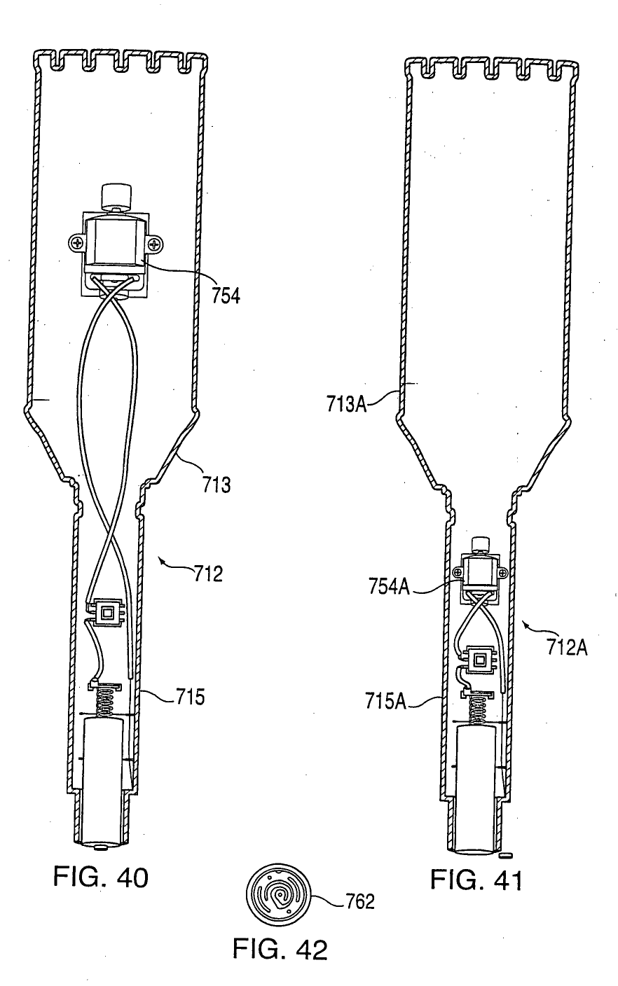

FIG. 40 shows another brush handle 712. Handle 712 is similar to brush handle 212C shown in FIG. 13 and it includes a top portion 713 with a scalloped edge 711 and a bottom portion 715. The edge 711 can flax radially allow a corresponding brush head (not shown) to be inserted over the handle top 713. Brush handle 712 includes a motor 754 disposed in the top portion 713.

FIG. 41 shows a brush handle 712A similar to handle 712, but with a motor 754A disposed in bottom portion 715A rather then top portion 713A. Brush handles 712, 712A have caps, such as cap 762 (shown in FIG. 42) closing the respective battery compartments in these handles.

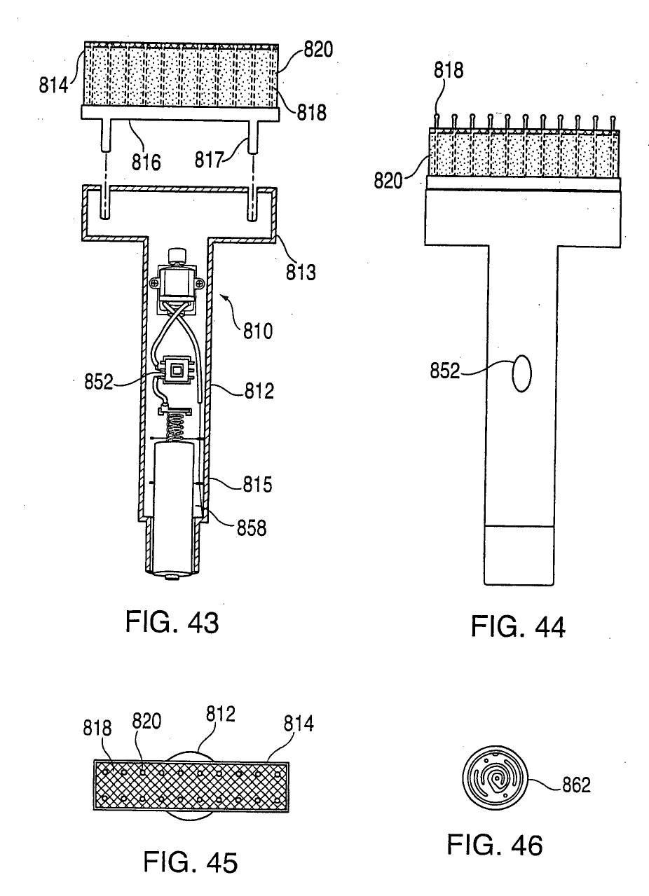

FIGS. 43, 44 and 45 show a pick-style brush 810 similar to the brush shown in FIGS. 34-36. Brush 810 has a handle 812 and a head 814. Handle 812 includes an upper portion 813 and a lower portion 815. Head 814 includes base 816 with bristles 818 and matrix 820. A plurality of legs 817 extend downwardly from base 816 as shown.

Upper portion 813 has apertures 819 that receive and form an interference fit with legs 817 thereby holding the head 814 attached to the handle 812. A motor 854 is disposed in the lower portion 815 as shown and is controlled by switch 852. The handle 812 is provided with an end cap 862 (FIG. 46) covering compartment 858.

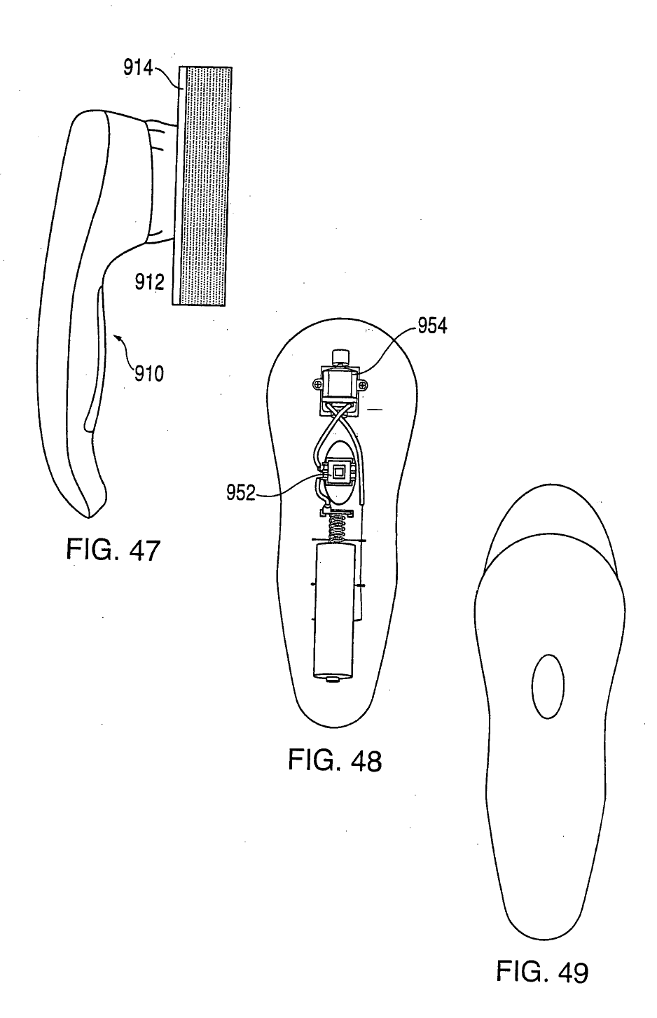

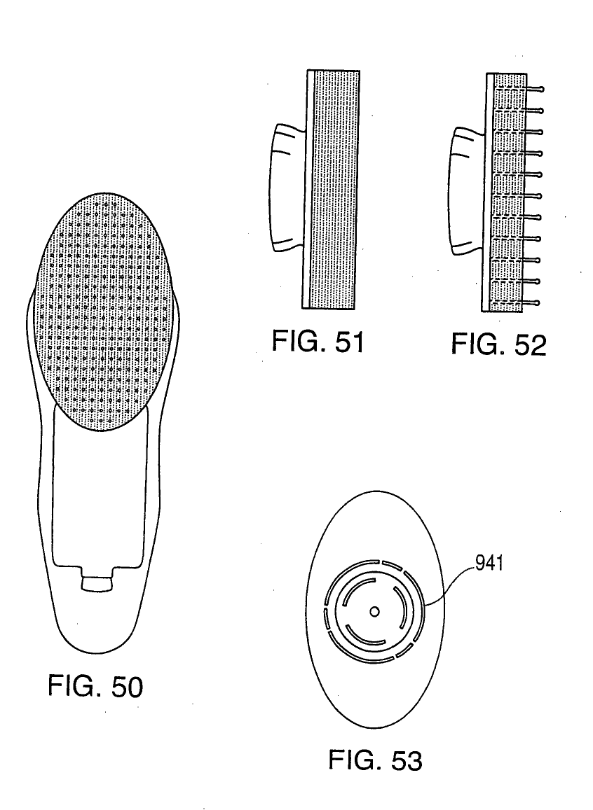

Another embodiment is shown in FIGS. 47-53. In this embodiment, brush 910 has a more compact size and ergonomical shape then the previously described brushes. Brush 910 includes a handle 912 and a head 914 removably attached to the handle.

Within the handle 912 there is a motor 954 controlled by a switch 952. The switch is accessible externally as shown in FIG. 49. An interface 940 is provided between the head 914 and the handle 912 that allows the head to be snapped on and off from the handle, as desired.

Obviously numerous modifications may be made to the invention without departing from its scope as defined in the appended claims.

1. (canceled)

2. The assembly of claim 19 wherein said surface is substantially planar.

3. (canceled)

4. The assembly of claim 22 wherein in said decompressed position, said bristles are fully embedded in said matrix.

5. The assembly of claim 22 wherein said matrix is covered with an external surface that is more dense and stiff than said matrix.

6. The assembly of claim 5 wherein said surface is a sheet made of a substantially water-proof material.

7. The assembly of claim 5 wherein said surface is a sheet made of substantially water absorbent material.

8. (canceled)

9. (canceled)

10. (canceled)

11. (canceled)

12. (canceled)

13. The assembly of claim 22 wherein said matrix is made of material selected from the group consisting of a polyurethane, polyester and polyethylene.

14. The assembly of claim 22 wherein said matrix is made of one of an open and a closed cell sponge.

15. The assembly of claim 22 further comprising a sheet covering said matrix, wherein said sheet is made of one of a woven or nonwoven substrate selected from the group consisting of polyethylene and polypropylene, polyesters, polyamides, synthetic celluloses and blends thereof.

16. The assembly of claim 15 wherein said sheet is a coating made from a material selected from a group consisting of ink, heat expandable prepolymer resin, varnish, silicone and wax.

17. (canceled)

18. (canceled)

19. A brush assembly for removing materials in hair or fur, comprising:
a replaceable or permanent handle sized and shaped to be grasped in a hand and terminating at one end with a neck;
a head mounted on said neck and including a base with a surface having a plurality of bristles mounted in an array; and
a vibrating device arranged and constructed to provide massage and improved cleaning.

20. The assembly of claim 19 wherein said vibrating device includes a motor, a battery providing power to the motor and a switch activating the motor.

21. The assembly of claim 20 wherein said motor has a shaft and an unbalanced counterweight mounted on said shaft for rotation.

22. The assembly of claim 19 further comprising a matrix disposed on said bristles, said matrix being compressed when the brush is in use, said matrix decompressing after use to remove material from said bristles.

23. The assembly of claim 22 wherein said said matrix is selectively attachable to and detachable from said base.

24. The assembly of claim 19, wherein said neck has a flexible edge to enable said head to be mounted on said neck.

25. The assembly of claim 20, wherein said motor is located in said neck.

26. The assembly of claim 20, wherein said motor is located in said handle.

27. The assembly of claim 19, wherein the head is removably attached to the handle by a snap-on mechanism.
